(19) United States
(12) Patent Application Publication
(10) Pub. No.: US 2018/0230679 A1
(43) Pub. Date: Aug. 16, 2018

(54) BOLT HEAD HOLDING TOOL AND METHODS OF FASTENING BUCKET LIP PROTECTORS

(71) Applicant: Freeport-McMoRan Inc., Phoenix, AZ (US)

(72) Inventors: Tommy Duncan, Phoenix, AZ (US); Joe Murillo, Phoenix, AZ (US); Samuel Compton, Phoenix, AZ (US); Jerry Burnette, Phoenix, AZ (US); Timothy Jake Bennett, Phoenix, AZ (US)

(21) Appl. No.: 15/894,113

(22) Filed: Feb. 12, 2018

Related U.S. Application Data
(60) Provisional application No. 62/459,732, filed on Feb. 16, 2017.

(51) Int. Cl. E02F 9/28; B25B 5/14; B25B 5/10

(52) U.S. Cl. CPC E02F 9/2891; B25B 5/10; B25B 5/14; E02F 9/2883

(57) ABSTRACT

A tool for temporarily holding a bolt within a through hole defined by the mating engagement of first and second members includes a beam member having a proximal end and a distal end. An arm mounted to the beam member includes a clamp end sized to engage at least a portion of a first side of an assembly defined by the mating engagement of the first and second members. A bolt support member mounted to the distal end of the beam member holds the head of the bolt against the second side of the assembly when the clamp end of the arm is engaged with the first end of the assembly.

### CROSS-REFERENCE TO RELATED APPLICATION

This application claims the benefit of U.S. Provisional Patent Application No. 62/459,732, filed on Feb. 16, 2017, which is incorporated herein by reference for all that it discloses.

### TECHNICAL FIELD

The present invention relates to tools in general and more particularly to tools for holding bolts used to secure lip protectors to excavation equipment.

### BACKGROUND

Excavation machines, such as power shovels, backhoes, and wheel loaders often use lip protection devices or shrouds on the excavation buckets thereof to decrease bucket wear and to focus dig-induced erosion and wear on easily replaceable components, namely the lip protectors. While a wide variety of lip protectors are known and used, most lip protectors are designed and manufactured to provide a cutting surface optimized for the particular material being excavated. Many such lip protectors are secured to the excavation bucket by one or more bolts provided in countersunk holes, although other mounting arrangements are known. While the countersunk holes reduce bolt wear by shielding the bolt heads and nuts from shear and erosion forces during excavator operation, they can make it more difficult to remove and replace the lip protectors.

### SUMMARY OF THE INVENTION

One embodiment of a tool for temporarily holding a bolt within a through hole defined by the mating engagement of first and second members includes a beam member having a proximal end and a distal end. An arm mounted to the beam member includes a clamp end sized to engage at least a portion of a first side of an assembly defined by the mating engagement of the first and second members. A bolt support member mounted to the distal end of the beam member holds the head of the bolt against the second side of the assembly when the clamp end of the arm is engaged with the first end of the assembly.

Also disclosed is a method of fastening a lip protector to the lip of an excavation bucket that involves: Placing the lip protector on the lip of the excavation bucket, the lip protector having a countersunk hole defined therein that is aligned with a hole defined in the excavation bucket; providing a tool having a beam member, an arm mounted to the beam member, the arm having a clamp end sized to engage a portion of an upper side of the lip protector, and a bolt support member mounted to the beam member; engaging the clamp end of the arm of the tool with a portion of an upper side of the lip protector; inserting a bolt into the countersunk hole in the lip protector so that the bolt head is located on a lower side of the lip protector; engaging the bolt support member of the tool with the bolt head; and threading a nut onto the bolt, the bolt support member of the tool holding the bolt head within the countersunk hole during the threading.

### BRIEF DESCRIPTION OF THE DRAWINGS

Illustrative and presently preferred exemplary embodiments of the invention are shown in the drawings in which:

FIG. 1 is a perspective view of one embodiment of a holding tool according to the present invention;

FIG. 2 is a side view in elevation of a holding tool illustrated in FIG. 1;

FIG. 3 is an enlarged side view in elevation of the holding tool being used to engage a lip protector and support a head of a plow bolt;

FIG. 4 is a perspective view of another embodiment of the holding tool as it could be used to engage a lip protector and support a head of a plow bolt; and

FIG. 5 is a flow chart representation of one embodiment of a method of using a holding tool.

### DETAILED DESCRIPTION OF THE PREFERRED EMBODIMENTS

The teachings of the present invention describe various embodiments and elements of a tool 10 for temporarily holding a bolt 36 within a through hole defined by the mating engagement of a first member and a second member. In an exemplary application, the first and second members may comprise a lip protector 26 and an excavation bucket 28, respectively. The tool 10 may be used to engage at least a portion of the lip protector 26 while it simultaneously holds the bolt 36 against the underside of the excavation bucket 28, thereby allowing a nut 42 to be easily threaded onto bolt 36. Alternatively, of course, tool 10 may be used in other applications as well.

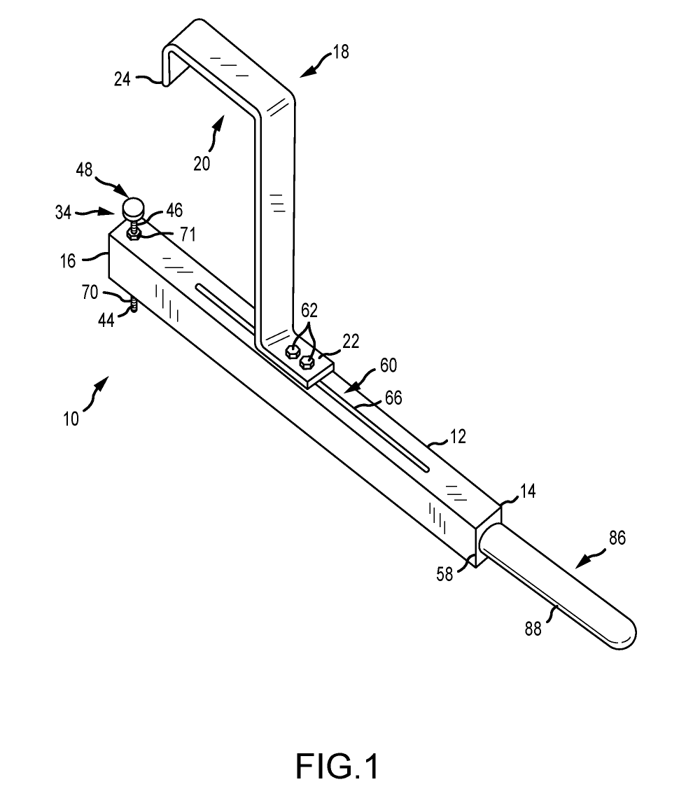

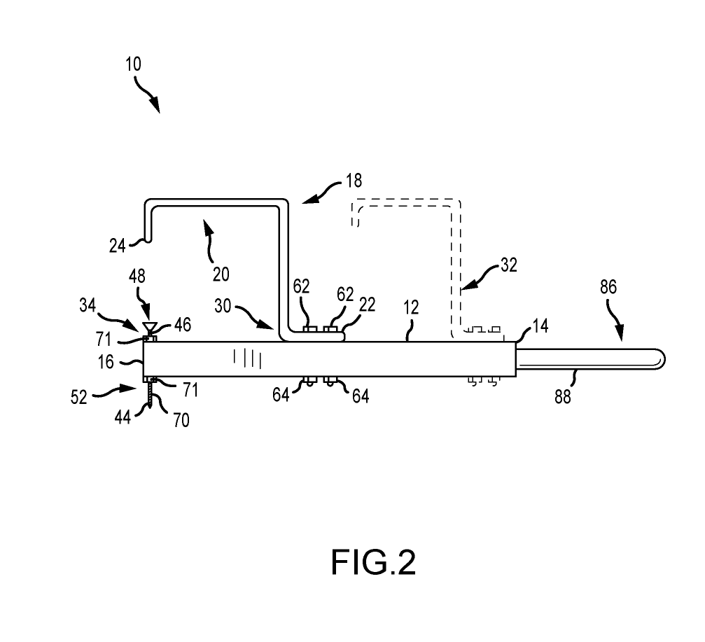

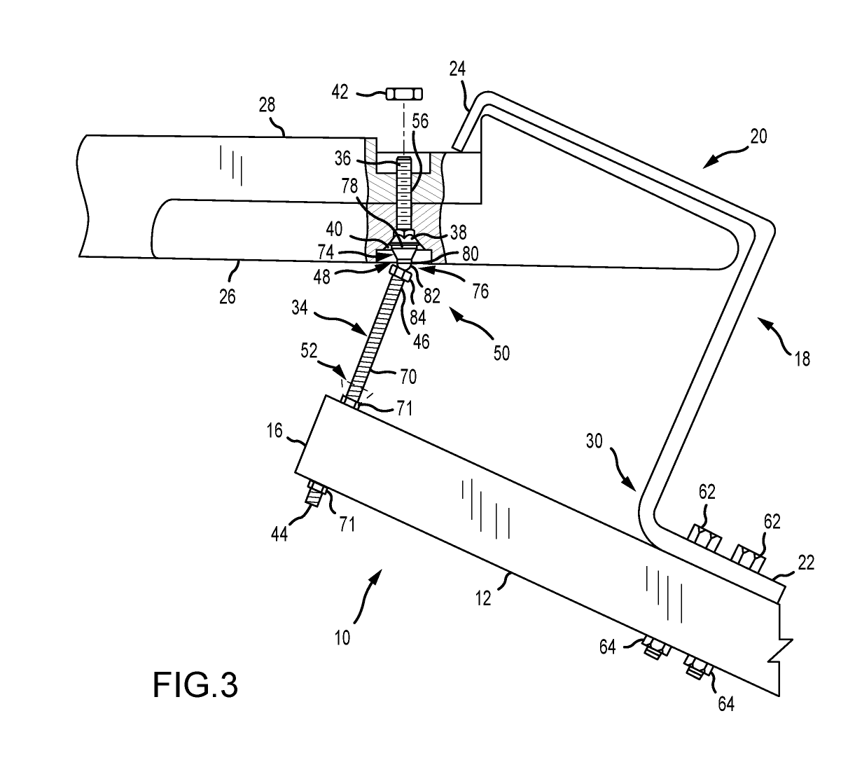

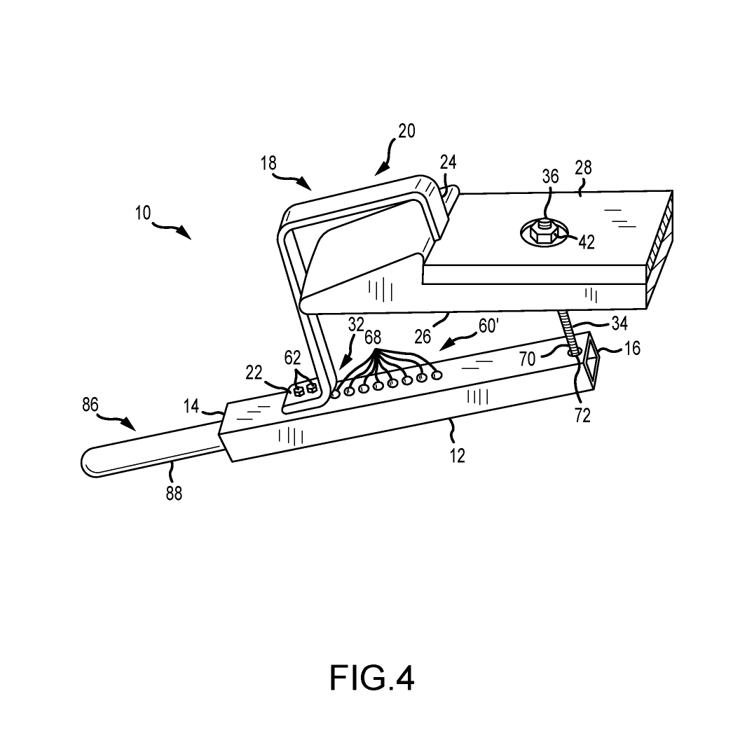

Referring now primarily to FIG. 1, one embodiment of bolt holding tool 10 may comprise a beam member 12 having a proximal end 14 and a distal end 16. An arm 18 may be mounted to the beam member 12 between its proximal 14 and distal 16 ends. More specifically, the arm 18 may comprise a generally U-shaped or hook-shaped member 20 having a mounting end 22 and a clamp end 24. The mounting end 22 may be mounted to the beam member 12, while the clamp end 24 may be shaped or configured to engage a portion of an upper side of lip protector 26 that is to be fastened to excavation bucket 28. See FIGS. 3 and 4. Arm 18 may be movably mounted to the beam member 12, such that it can be moved between an extended position 30 (best seen in FIG. 2) and a retracted position 32 (shown in FIG. 4 and with broken lines in FIG. 2) with respect to the beam member 12. The movable mounting arrangement allows holding tool 10 to accommodate different types and sizes of lip protectors 26 and excavation buckets 28.

Holding tool 10 may also comprise a bolt support member 34 mounted to the distal end 16 of the beam member 12. Bolt support member 34 allows the holding tool 10 to support a plow bolt 36 on the underside of the lip protector 26. More specifically, the bolt support member 34 may be configured or designed to support a head 38 of plow bolt 36 situated within a countersunk hole 40 formed in the lower side of the lip protector 26. Plow bolt 36 may be provided with a square shoulder sized to be received by a square portion of the countersunk hole 40. The engagement of the square shoulder within the square portion of countersunk hole 40 prevents plow bolt 36 from rotating when the same is fully seated in countersunk hole 40.

In the particular embodiments shown and described herein, bolt support member 34 may comprise a proximal end 44 and a distal end 46. A swivel head 48 mounted to the distal end 46 of bolt support member 34 allows the bolt support member 34 to support the head 38 of plow bolt 36 even though bolt support member 34 may not be axially aligned with plow bolt 36. See FIG. 3. In one embodiment, bolt support member 34 may be movably mounted to the distal end 16 of the beam member 12, so that the bolt support member 34 can be moved with respect to beam member 12 between an extended position 50 (best seen in FIG. 3) and a retracted position 52 (illustrated in FIG. 2 and with broken lines in FIG. 3).

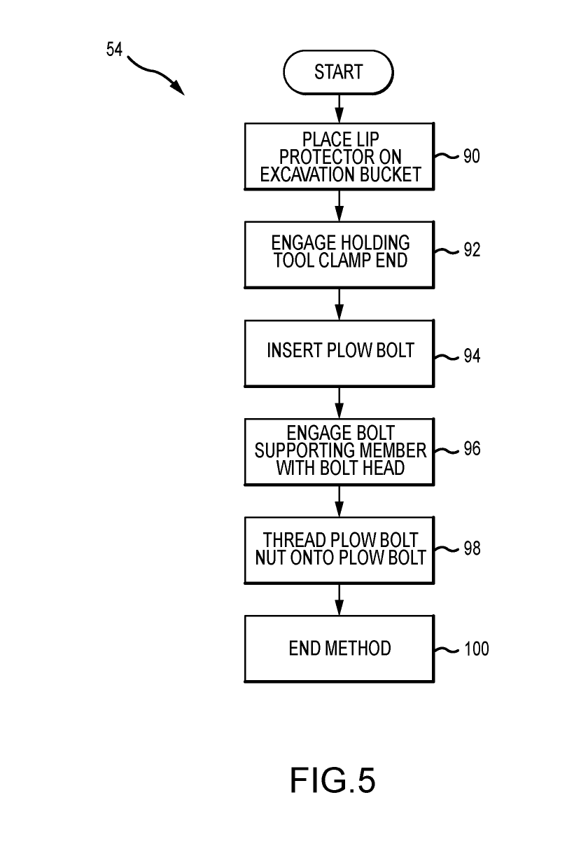

Referring now primarily to FIG. 5, a user (not shown) may utilize holding tool 10 in accordance with a method 54 to fasten a lip protector 26 to the lip of an excavation bucket 28. In a first step 90, the user may place the lip protector 26 on the lip of the excavation bucket 28. The lip protector 26 may be provided with one or more countersunk holes 40 that are sized and configured to align with one or more corresponding holes 56 provided in the excavation bucket 28. See also FIG. 3. When the lip protector 26 and excavation bucket 28 are properly aligned, holes 40 and 56 define a through hole though both pieces. The user may then engage, at step 92, the clamp end 24 of the holding tool 10 with a portion of the upper side of the lip protector 26. At step 94, the user may insert plow bolt 36 through the lower side of the lip protector 26, until the head 38 of plow bolt 36 is fully seated within countersunk hole 40 provided in lip protector 26. The user may then engage, at step 96, bolt support member 34 of the holding tool 10 with the plow bolt head 38. The engagement holds in place plow bolt 36 within through hole (i.e., defined by the alignment of holes 40 and 56 in lip protector 26 and excavation bucket 28) and prevents plow bolt 36 from falling out. During step 98, the user may then thread a plow bolt nut 42 onto the plow bolt 36, i.e., from the upper side of the excavation bucket 28. The engagement of tool 10 with the head 38 of plow bolt 36 ensures that the plow bolt 36 remains fully seated in countersunk hole 40, thereby allowing plow bolt nut 42 to be tightened to the specified torque without concern that plow bolt 36 will become unseated from countersunk hole 40. After threading the plow bolt nut 42 onto the plow bolt 36, the user may remove the holding tool 10 and terminate the method 54 at step 100.

The holding tool 10 and method 54 increase the safety and efficiency with which users may attach and replace lip protectors 26 on excavation buckets 28. The holding tool 10 permits a user to support the plow bolt 36 while simultaneously fastening or removing the plow bolt nut 42 on the upper side of the excavation bucket 28, all without requiring the user to reach his or her hands underneath the heavy lip protector 26 and risk injury. The holding tool 10 may also allow a user to engage a separate tool, such as an air impact wrench, to tighten or loosen the plow bolt nut 42 while simultaneously supporting the plow bolt 36 in the countersunk hole 40.

Having briefly described one embodiment of the holding tool 10, as well as some of its more significant features and advantages, various embodiments and alternative configurations of the holding tool 10 and method 54 will now be described in detail.

Referring back now to FIGS. 1 and 2, and as briefly described earlier, holding tool 10 may comprise a beam member 12 having a proximal end 14 and a distal end 16. Beam member 12 may comprise any of a range of sizes, cross-sectional configurations, and materials suitable for the particular application. By way of example, in one embodiment, beam member 12 may comprise a straight, bar-shaped form 58 having a square cross-section, as best seen in FIG. 1, although other shapes and cross-sectional configurations are possible. Beam member 12 may be fabricated from any of a wide range of materials, such as metal or fiberglass, depending on the particular application. In one embodiment, beam member 12 is fabricated from mild steel.

Holding tool 10 may also comprise an arm 18 to allow the holding tool 10 to engage a portion of the lip protector 26 or excavation bucket 28 in the manner described herein. In one embodiment, arm 18 may comprise a generally U-shaped or hook-shaped member 20 having a mounting end 22 and a clamp end 24. In the particular embodiments shown and described herein, mounting end 22 may comprise a generally flat end section that provides sufficient area to allow arm 18 to be securely mounted to beam member 12. Clamp end 24 of arm 18 may comprise a generally hook-like portion or end that is configured to engage at least a portion of the lip protector 26, as best seen in FIGS. 3 and 4. Preferably, clamp end 24 of arm 18 may engage a protrusion or edge of the lip protector 26 or excavation bucket 28. The arm 18 may be fabricated from any of a wide range of materials suitable for the particular application. By way of example, in one embodiment, arm 18 is fabricated from mild steel.

It is generally preferred, but not required, that arm 18 be movably mounted to the beam member 12 so that it can be moved with respect to beam member 12 between an extended position and a retracted position 32, as best seen in FIG. 2.

Fastening means 60 may provide this moveable mounting arrangement. In one embodiment, best viewed in FIG. 1, the fastening means 60 may comprise an elongated slot 66 provided in beam member 12. One or more bolts 62 and nuts 64 may be used to secure the end section of arm 18 at various positions along slot 66, thus beam member 12. The bolts 62 and nuts 64 may be loosened to permit the arm 18 to be moved along beam member 12 before being tightened again to secure the arm 18 at a particular location on the beam member 12. In this manner, the arm 18 may be adjusted from a fully extended position 30, where the arm 18 is near distal end 16 of beam member 12, to a fully retracted position 32, where the arm 18 is near proximal end 14 of beam member 12. Such adjustments permit holding tool 10 to be used with a wide variety of lip protectors 26 and excavation buckets 28.

Other embodiments of the fastening means 60 are possible. For example, and as illustrated in FIG. 4, another embodiment 60′ of fastening means may comprise a plurality of holes 68 provided in beam member 12 that are sized to receive corresponding bolts 62. This alternative fastening means 60′ permits the user (not shown) to mount arm 18 at a variety of discrete positions along beam member 12. When the arm 18 is located at the desired position along beam member 12, the user may then insert bolts 62 through the corresponding holes 68. Nuts (not shown in FIG. 4) may then be threaded onto bolts 62 to secure the arm 18 at the desired position. Still other arrangements of fastening means 60, 60′ are possible, as would become apparent to persons having ordinary skill in the art after having become familiar with the teachings provided herein. Consequently, the present invention should not be regarded as limited to any particular type of fastening means 60, 60′.

As previously stated, holding tool 10 may also comprise a bolt support member 34 mounted to the distal end 16 of the beam member 12. In an embodiment, the bolt support member 34 may be moveably mounted to the beam member 12 to enable the holding tool 10 to accommodate lip protectors 26 and excavation buckets 28 of various sizes. In a further embodiment, the bolt support member 34 may have a proximal end 44 and a distal end 46. The bolt support member 34 may further comprise a threaded portion 70, and the distal end 16 of the beam member 12 may define a threaded hole 72 that is sized to receive the threaded portion 70 of the bolt support member 34 (best seen in FIG. 4). In this way, the bolt support member 34 may be rotated with respect to the beam member 12 to move bolt support member 34 between an extended position 50 (best seen in FIG. 3) and a retracted position 52 (illustrated in FIG. 2 and with broken lines in FIG. 3). One or more nuts 71 may be threaded onto the threaded portion 70 of the bolt support member 34 and secured to the distal end 16 of the beam member 12 in order to fix or lock the position of the bolt support member 34 with respect to the beam member 12.

The bolt support member 34 may further comprise a swivel head 48 provided on distal end 46 of bolt support member 34. Swivel head 48 allows bolt support member 34 to support the head 38 of the plow bolt 36 even when the bolt support member 34 is not fully aligned with the plow bolt 36. See FIG. 3. In the particular embodiments shown and described herein, swivel head 48 may comprise a cone-shaped member 74 and a ball mount 76. See FIG. 3. The cone-shaped member 74 may have a flat end 78 and a socket end 80. The ball mount 76 may comprise a ball 82 mounted to a flat end 84 provided on the distal end 46 of the bolt support member 34. The socket end 80 of the cone-shaped member 74 may attach to the ball 82 in such a manner as to permit the cone-shaped member 74 to move and swivel in the manner of a ball-and-socket joint with respect to the distal end 46 of bolt support member 34. The flat end 78 of the cone-shaped member 74 may be sized to support plow bolts 36 of various sizes. In an embodiment, the cone-shaped member 74 and ball mount 76 may be fabricated from steel.

The holding tool 10 may additionally comprise a handle 86 mounted to the proximal end 14 of the beam member 12. See FIG. 1. Handle 86 may provide a convenient means for a user to grip and manipulate the holding tool 10 and to exert leverage on the lip protector 26 to hold the plow bolt 36 in position. In one embodiment, the handle 86 may comprise a generally cylindrically-shaped member 88 sized to be gripped by one or both of the user's hands. The handle 86 may be fabricated from mild steel, although other materials may be used. Alternatively, handle 86 need not comprise a separate member, but instead could comprise an extension of proximal end 14 of beam member 12.

With reference now primarily to FIG. 5, a user (not shown) may use the holding tool 10 in conjunction with a method to fasten a lip protector 26 to the lip of an excavation bucket 28. Before initiating the method 54, in an embodiment of the holding tool 10, the user may adjust the position of the arm 18 on the beam member 12 by adjusting its fastening means 60, as is described above. The user may also adjust the position of the bolt support member 34 by rotating it with respect to the beam member 12 as is described above, thereby optimizing the configuration of the holding tool 10 to the particular lip protector 26 to be fastened.

The user may begin the method 54 at step 90 by placing the lip protector 26 on the lip of the excavation bucket 28. The lip protector 26 may contain one or more countersunk holes 40 sized to receive the plow bolts 36. Further, each countersunk hole 40 may be provided with a square counterbore sized to engage the square neck of the plow bolt 36. This arrangement will prevent the plow bolt 36 from rotating when plow bolt 36 is fully seated within countersunk hole 40. When the lip protector 26 is properly positioned with respect to the excavation bucket 28, each countersunk hole 40 will be aligned with a corresponding hole 56 provided in the excavation bucket 28. This alignment will allow the user to insert a plow bolt 36 through both holes 40 and 56, as is best seen in FIG. 3.

After placing the lip protector 26 on the lip of the excavation bucket 28, the user may proceed to step 92 by engaging the clamp end 24 of the holding tool 10 with a portion of the upper side of the lip protector 26 or excavation bucket 28. The clamp end 24 may engage or abut against a protrusion or edge of the lip protector 26 or excavation bucket 28, as best seen in FIGS. 3 and 4. Next, at step 94, the user may insert a plow bolt 36 through the lower side of the lip protector 26. The shaft of the plow bolt 36 may pass through both the countersunk hole 40 in the lip protector 26 and the corresponding hole 56 in the excavation bucket 28. In an embodiment, the square neck of the plow bolt 36 may engage with and fit into the square counterbore formed in countersunk hole 40, thereby preventing the plow bolt 36 from rotating when fully seated.

The user may now, at step 96, move the holding tool 10 so that the bolt support member 34 engages the head 38 of the plow bolt 36. This engagement will prevent plow bolt 36 from becoming unseated from, or otherwise falling out of countersunk hole 40. In one embodiment, the swivel head 48 provided on distal end 46 of bolt support member 34 engages the head 38 of the plow bolt 36 even though the bolt support member 34 is not aligned with plow bolt 36. See FIG. 3.

Now at step 98, the user may thread a plow bolt nut 42 onto the plot bolt 36, thereby securing the lip protector 26 to the excavation bucket 28. The holding tool 10 prevents the plow bolt 36 from becoming unseated from the countersunk hole 40, thereby allowing the plow bolt nut 42 to be tightened to the specified torque without concern that the plow bolt 36 will turn within countersunk hole 40. The user may use a separate tool, such as an air impact wrench (not shown), to tighten the plow bolt nut 42 while supporting the plow bolt 36 with the holding tool 10, although such use of separate tools is not required. Having threaded the plow bolt nut 42 onto the plow bolt 36, the user may remove the tool 10 and terminate, at step 100, the method 54.

Having herein set forth preferred embodiments of the present invention, subsequent suitable modifications may be made thereto which will nonetheless remain within the scope of the invention. The invention shall therefore only be construed in accordance with the following claims:

1. A tool for temporarily holding a bolt within a through hole defined by a mating engagement of a first member and a second member, the mating engagement of the first and second members defining an assembly having at least a first side and a second side, comprising:
a beam member having a proximal end and a distal end;
an arm mounted to said beam member, said arm having a clamp end sized to engage at least a portion of the first side of the assembly; and
a bolt support member mounted to the distal end of said beam member, said bolt support member sized to engage a head of the bolt and hold the head of the bolt against the second side of the assembly when the clamp end of said arm is engaged with the first side of the assembly.

2. The tool of claim 1, further comprising a handle mounted to the proximal end of said beam member.

3. The tool of claim 1, wherein said arm is moveably mounted to said beam member so that said arm can be moved with respect to said beam member between an extended position and a retracted position.

4. The tool of claim 3, further comprising fastening means operatively associated with said arm and said beam member for allowing said arm to be fastened to said beam member at various locations between the extended and retracted positions.

5. The tool of claim 4, wherein said fastening means comprises a bolt and a nut and wherein said beam member defines an elongated slot therein sized to receive said bolt, the engagement of said bolt with the slot allowing said arm to be fastened to said beam member at the various locations between the extended and retracted positions.

6. The tool of claim 4, wherein said fastening means comprises a bolt and a nut and wherein said beam member defines a plurality of holes therein sized to receive said bolt, the engagement of said bolt with at least one of the plurality of holes allowing said arm to be fastened to said beam member at the various locations between the extended and retracted positions.

7. The tool of claim 1, wherein said arm comprises a generally hook-shaped member.

8. The tool of claim 1, wherein said bolt support member is movably mounted to the distal end of said beam member so that said bolt support member can be moved between an extended position and a retracted position.

9. The tool of claim 8, wherein said bolt support member further comprises a swivel head mounted to a distal end thereof, said swivel head being engagable with the bolt head.

10. The tool of claim 9, wherein said swivel head comprises:
a cone-shaped member having a flat end and a socket end; and
a ball mount sized to be received by the socket end of said cone-shaped member.

11. The tool of claim 10, wherein a proximal end of said bolt support member comprises a threaded portion and wherein the distal end of said beam member defines a threaded hole therein sized to engage the threaded portion of said bolt support member, rotation of the threaded portion of said bolt support member within the threaded hole moving said bolt support member between the extended and retracted positions.

12. The tool of claim 8, wherein a proximal end of said bolt support member comprises a threaded portion and wherein the distal end of said beam member defines a through hole sized to pass the threaded portion of said bolt support member, said tool further comprising at least one nut, said at least one nut securing the bolt support member to the distal end of said beam member at a location between the extended and retracted positions.

13. The tool of claim 1, wherein said beam member comprises a hollow member having a square cross-section.

14. The tool of claim 1, wherein said beam member comprises mild steel.

15. The tool of claim 1, wherein said arm comprises mild steel.

16. The tool of claim 2, wherein said handle comprises a generally cylindrically-shaped member.

17. A tool for temporarily holding a bolt within a through hole defined by a mating engagement of a first member and a second member, the mating engagement of the first and second members defining an assembly having at least a first side and a second side, comprising:
a beam member having a proximal end and a distal end;
a handle mounted to the proximal end of said beam member;
an arm having a clamp end sized to engage at least a portion of the first side of the assembly, said arm being moveably mounted to said beam member so that said arm can be moved with respect to said beam member between an extended position and a retracted position; and
a bolt support member having a swivel head sized to engage a head of the bolt, said bolt support member being moveably mounted to the distal end of said beam member so that the swivel head of said bolt support member can be moved with respect to said beam member between a retracted position and an extended position, the swivel head of the bolt support member holding the head of the bolt against the second side of the assembly when the clamp end of said arm is engaged with the first side of the assembly.

18. A method of fastening a lip protector to a lip on an excavation bucket, comprising:
placing the lip protector on the lip of the excavation bucket, the lip protector having a countersunk hole defined therein that is aligned with a hole defined in the excavation bucket;
providing a tool having a beam member, an arm mounted to the beam member, the arm having a clamp end sized to engage a portion of an upper side of the lip protector, and a bolt support member mounted to the beam member;
engaging the clamp end of the arm of the tool with a portion of an upper side of the lip protector;
inserting a bolt into the countersunk hole in the lip protector so that a head of the bolt is located on a lower side of the lip protector;
engaging the bolt support member of the tool with the bolt head; and
threading a nut onto the bolt, the bolt support member of the tool holding the bolt head within the countersunk hole during said threading.

19. The method of claim 18, wherein the arm of said tool is moveably mounted to the beam member of said tool so that the arm can be moved with respect to said beam member between an extended position and a retracted position, said method further comprising, after providing said tool and before engaging the clamp end of the arm of the tool with a portion of an upper side of the lip protector:
adjusting the position of the arm with respect to the beam member of the tool so that bolt support member is generally aligned with the head of the bolt when the clamp end of the arm is engaged with at least a portion of the upper side of the lip protector.

20. The method of claim 18, wherein the bolt support member of said tool is movably mounted to the beam member of said tool so that the bolt support member can be moved with respect to said beam member between an extended position and a retracted position, said method further comprising, after providing said tool and before engaging the clamp end of the arm of the tool with a portion of an upper side of the lip protector:
adjusting the position of the bolt support member with respect to the beam member of the tool so that the bolt support member is engaged with the head of the bolt when the clamp end of the arm is engaged with at least a portion of the upper side of the lip protector.
